(19) United States
(12) Patent Application Publication
(10) Pub. No.: US 2008/0257113 A1
(43) Pub. Date: Oct. 23, 2008

(54) Stake driver

(76) Inventor: Arthur F. Neumarkel, Anacortes, WA (US)

Correspondence Address: KRAJEC PATENT OFFICES, LLC, 820 WELCH AVENUE, BERTHOUD, CO, 80513, US

(21) Appl. No.: 11/548,750

(22) Filed: Oct. 12, 2006

(51) Int. Cl. B25D 1/16

(52) U.S. Cl. 81/27

(57) ABSTRACT

A manually operated stake driver has a slide hammer and guide. The guide is fitted with a receiver that captures and guides the stake. The slide hammer provides percussion force directly to the stake by extending into the receiver when the slide hammer is actuated. The slide hammer may have a weight attached or incorporated into a handle to provide additional force to the stake when actuated. In one embodiment, the stake driver may be designed to be used while the operator is standing and to drive stakes into the ground.

### BACKGROUND

Stakes are used in many construction projects and may be driven into the ground or other materials for various reasons. Permanent or temporary locational or fastening may be accomplished with metal, wood, or other types of stakes.

On some jobsites, a large quantity of stakes may be required to be driven. For example, metal stakes are commonly used in concrete flatwork as temporary support for forms. When forming a large driveway, a hundred or more stakes may be required to be driven into the ground. Typically, this is done with a sledge hammer. Because the stakes are typically metal and the hammer handle is wood, an improperly struck stake can damage or destroy the hammer handle. Further, since the flatwork forms are generally a few inches tall, workers must bend down near the ground to drive each stake.

### SUMMARY

A manually operated stake driver has a slide hammer and guide. The guide is fitted with a receiver that captures and guides the stake. The slide hammer provides percussion force directly to the stake by extending into the receiver when the slide hammer is actuated. The slide hammer may have a weight attached or incorporated into a handle to provide additional force to the stake when actuated. In one embodiment, the stake driver may be designed to be used while the operator is standing for the purpose of driving stakes into the ground.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a stake driver being used by an operator.

FIG. 2 is an exploded perspective illustration of an embodiment of a stake driver.

FIG. 3 is a cross-sectional illustration of an embodiment of a stake driver.

FIG. 4 is a cross-sectional illustration of an embodiment of the receiver portion of a stake driver.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

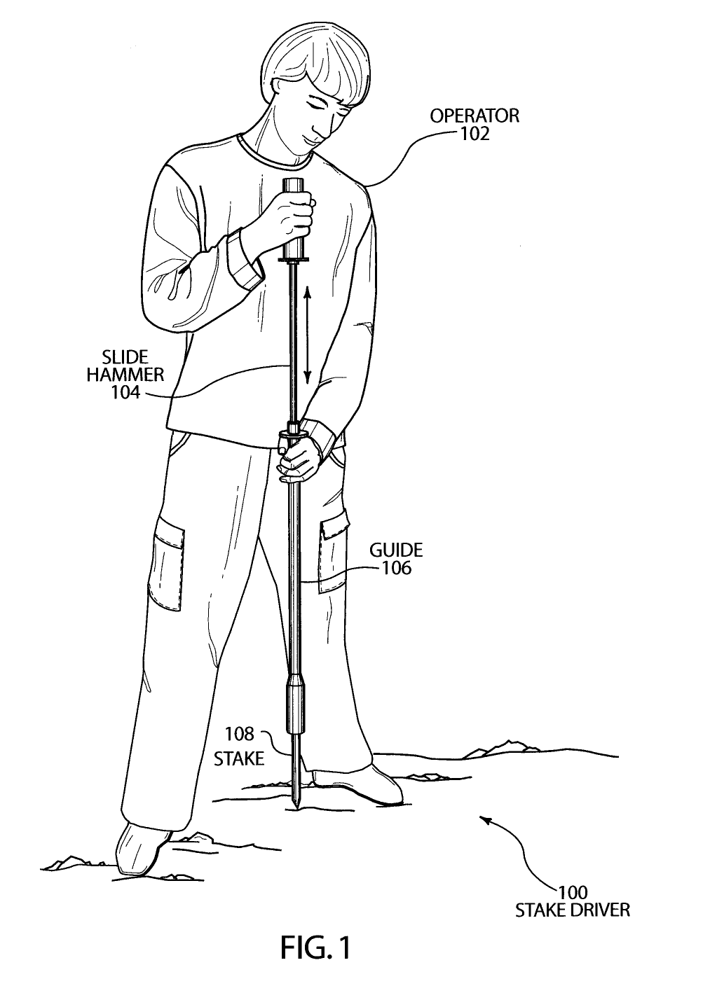

FIG. 1 is a diagram of an embodiment 100 showing a stake driver in use. An operator 102 is using a slide hammer 104 that slides within a guide 106 to drive a stake 108 into the ground. The slide hammer 104 is manually operated and can reciprocate up and down to drive the stake 108. The slide hammer 104 has a shaft that extends through the guide 106 and strikes the top of the stake 108 directly. The direct contact between the slide hammer 104 and the stake 108 is the primary mechanism by which the stake 108 can be driven into the ground.

The embodiment 100 is a device by which stakes can be driven into the ground. One application is the installation of forms used for concrete flatwork. Such stakes are generally steel rods approximately ½ to ¾ inch in diameter and may be from 12 inches to 24 inches in length. Several stakes may be driven into the ground to support formwork prior to pouring concrete for walkways, driveways, and other flatwork. In a typical job, several hundred such stakes may be installed prior to pouring concrete.

Embodiment 100 is an embodiment where the operator 102 may stand during stake installation. When the operator 102 installs a stake 108 without the stake driver, he may have to bend over or kneel and use a hammer to drive the stake. Such an operation requires repeated bending over, which can be fatiguing. The operation also requires that the operator have good aim with the hammer, as a missed blow can damage the typically wooden hammer handle or cause injury to the operator.

Other embodiments may be used for other similar applications, including driving tent stakes, installing fence posts, or driving other objects into the ground. Other embodiments may also include any driving application where percussive force is applied directly to the driven object, which in the present embodiment is the stake 108. For example, a bearing shaft in a machine may be installed or a finish nail driven using different embodiments of a suitable size.

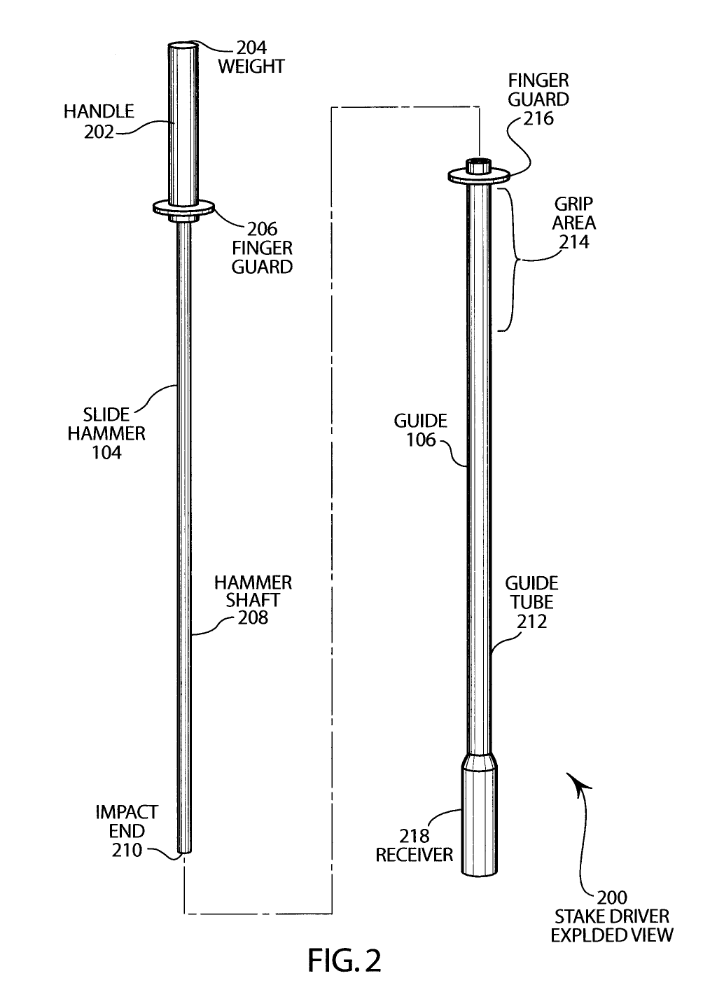

FIG. 2 is an exploded view of embodiment 200 showing an exploded view of a stake driver. The slide hammer 104 is shown removed from the guide 106. The slide hammer 104 comprises a handle 202 that may include an integral or detachable weight 204 and a finger guard 206. The slide hammer also has a hammer shaft 208 that has an impact end 210. The guide 106 has a guide tube 212 and a grip area 214 that has a finger guard 216. The receiver 218 is the portion of the guide 106 that captures and aligns the item to be driven.

Embodiment 200 is a simple, two-piece device that can efficiently and effectively apply percussive force to an object. The object to be driven, such as the stake 108, can be captured and held in the receiver 218. The impact end 210 of the slide hammer 104 extends into the receiver 218 and applies direct force onto the object to be driven.

The two-piece mechanism of embodiment 200 operates by the sliding of the hammer shaft 208 within the guide tube 212. In many embodiments, the guide tube 212 and hammer shaft 208 may be a circular cylinder and the two pieces may freely rotate as well as slide with respect to each other. In other embodiments, other shapes may be used to key the two pieces together and prevent rotation. Such embodiments may include square, rectangular, or other shaped cross sections.

The fit between the hammer shaft 208 and the guide tube 212 may be any type of fit that enables sliding action between the pieces. In some embodiments, a very precise fit between the pieces may be used for precise driving of specialized elements. In other embodiments, a very loose fit may be employed where such precision is not necessary. For example, in an embodiment for driving stakes for concrete flatwork may have 0.100 inch or more clearance between the external diameter of the hammer shaft 208 and the internal diameter of the guide tube 212.

The handle 202 may incorporate a weight 204. The weight 204 may be sized to provide an appropriate level of force while balancing the potential fatigue of an operator. In general, the weight 204 may be sized to be approximately the same weight as a typical hammer that may be used for the same intended purpose. For example, an embodiment that is used for driving finish nails or other fine woodworking applications may have a slide hammer 104 that weighs approximately 8 to 10 ounces, the comparable weight of a finish hammer. In another example, an embodiment that is used for driving large tent stakes may have a weight 204 that is comparable to a heavy sledge hammer that may weigh 8 to 10 pounds.

Some embodiments may have detachable weights that may be added or removed depending on the particular application. For example, an embodiment used for driving stakes for concrete flatwork may have an additional set of weights that may be added for driving stakes into very hard ground. Such weights may be removed when used in lighter ground.

The handle 202 and the grip area 214 may have finger guards 206 and 216. The finger guards may keep an operator's fingers from being pinched between the slide hammer 104 and the guide 106 when the slide hammer 104 is driven downward toward the receiver 218. In some embodiments, an operator may apply a downward force on the handle 202 and thus push against the finger guard 206, especially at impact.

Many different handle designs and configurations may be used by those skilled in the art. The handle design of the present embodiment is designed for a standing operator. The handle design may be changed for other uses and when the operator is in other positions. For example, a handle may be mounted in the grip area 214 so that the operator's lower hand grips a shaft that is perpendicular to the axis of the guide tube 212.

The embodiment 200 has a central axis on which the slide hammer 104 slides with respect to the guide tube 212. The embodiment 200 is a symmetrical design where the various parts are revolutions about a central axis. Other embodiments may not be revolutions about an axis, but would still have a sliding axis defined by the motion of the hammer shaft 208 in the guide tube 212.

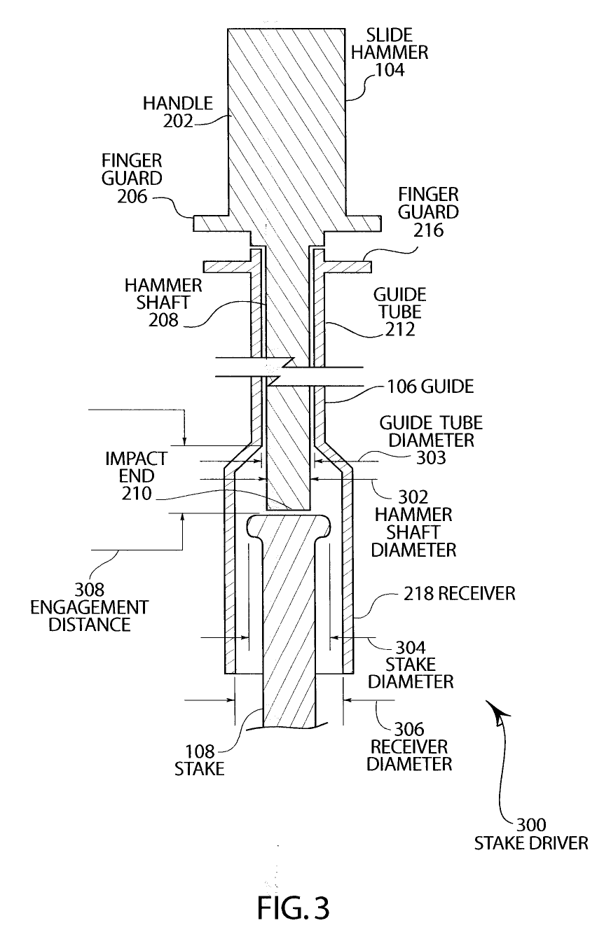

FIG. 3 is a cross-sectional view of an embodiment 300 showing a stake driver. The slide hammer 104, guide 106, and stake 108 are shown with the slide hammer 104 fully engaged in the guide 106. The slide hammer 104 is shown with the handle 202, the finger guard 206, and the impact end 210. The guide 106 is shown with the guide tube 212, the finger guard 216, and the receiver 218.

The guide tube diameter 303 is sized larger than the hammer shaft diameter 302 so that the hammer shaft 208 may freely move within the guide tube 212. In some embodiments, the guide tube diameter 303 may be substantially larger than the hammer shaft diameter 302 so that any deformation, distortion, or other abnormalities in the parts will not interfere with the free running motion. In an example of an embodiment designed to drive ¾ inch stakes, the hammer shaft diameter 302 may be 9/16 inch nominal diameter and the guide tube diameter 303 may be ⅝ inch. The hammer shaft diameter 302 may be reduced to ½ inch in some instances.

The guide tube diameter 303 is sized to be less than the stake diameter 304. Before striking a blow with the slide hammer 104, the stake 108 may be captured in the receiver 218. When the guide tube diameter 303 is smaller than the stake diameter 304, the guide 106 may be fully supported as the stake 108 is held within the receiver 218 and not able to intrude into the guide tube 212. Such an arrangement allows the slide hammer 104 to be retracted out of the guide 106 and then drawn downwardly the full length of the guide tube 212 to contact the stake 108 and administer a blow. Because the stake 108 is kept within the receiver 218, every stroke of the slide hammer 104 may be a full stroke.

The hammer shaft 208 extends into the receiver 218 by an engagement distance 308. With each blow of the slide hammer 104, the impact end 210 administers a percussion blow directly to the stake 108. The forces acting on the stake 108 do not travel through the receiver 218 into the guide 106, but are directly transmitted from the slide hammer 104 to the stake 108. Some embodiments may have a tapered receiver 218 such that the stake 108 is held close to the center of the axis of the guide tube 212, and thus the impact end 210 will make contact along the center of the stake 108 rather than a glancing blow off of the side.

The receiver diameter 306 is larger than the stake diameter 304 to allow for ease of insertion for the stake 108 into the receiver 218. The difference in the diameters 304 and 306 may be tailored for specific applications. When the objects to be driven are of a known and uniform diameter, the difference between diameters 304 and 306 may be small so that the receiver 218 may be used to help align the object to be driven. When the object to be driven are warped, damaged, or are non-uniform, the difference in diameters 304 and 306 may be large so that all variations of object to be driven may be accommodated.

In some embodiments, the impact end 210 may be adapted for specific purposes. For example, the impact end 210 may be hardened when driving hard objects. The hardened end or anvil may be a localized heat treatment to the hammer shaft 208 or may be a detachable and replaceable element attached to the end of the hammer shaft 208. In other embodiments, a soft element may be attached to the end of the hammer shaft 208, such as a brass or plastic tip designed to leave no marks or deformation on the stake 108. In some cases, the impact end 210 may be shaped in various fashions. For example, a concave shape, pointed shape, waffle face pattern, or any other texture, pattern, or shape may be used.

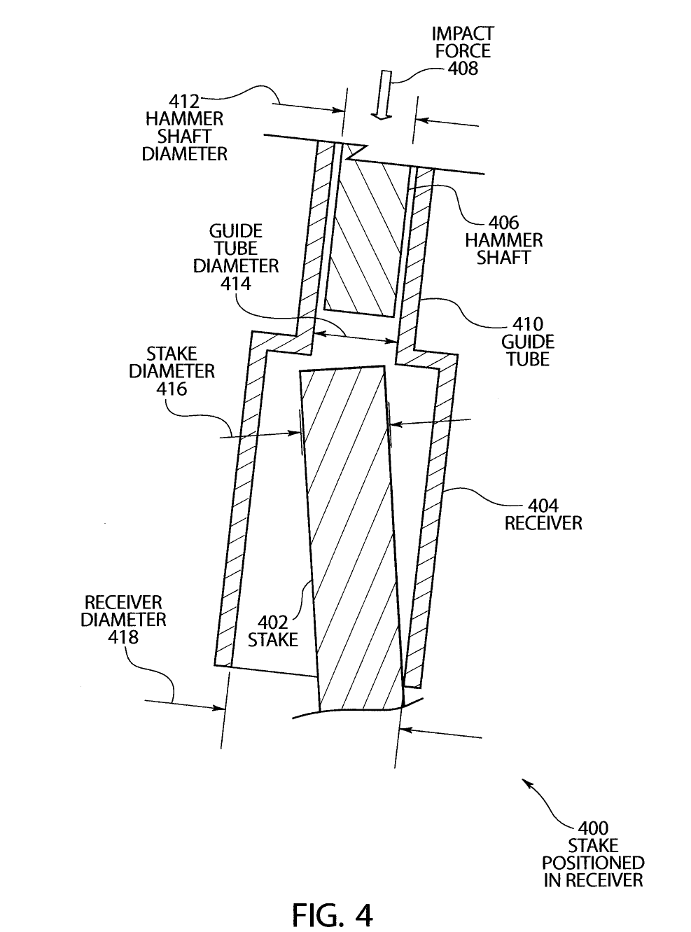

FIG. 4 is a cross-sectional view of an embodiment 400 showing a stake positioned in a receiver. A stake 402 is positioned in a receiver 404 at an angle. A hammer shaft 406 may exert an impact force 408 as it is moved down the guide tube 410.

The hammer shaft diameter 412 is less than the guide tube diameter 414 so that the hammer shaft 406 may freely move within the guide tube 410.

The stake diameter 416 is illustrated as substantially smaller than the receiver diameter 418, yet larger than the guide tube diameter 414. Because the diameters are sized as such, the stake 402 may be oriented, positioned, and held in the receiver 404 prior to and while applying the impact force 408. When an operator grasps the guide tube 410, he may position and hold the stake 402 in a very accurate manner as he applies the impact force 408. This mechanism allows an operator to place the stake 402 very accurately and quickly.

Because the stake 402 is fully engaged within the receiver 404, there is very little likelihood of the receiver 404 jumping off of the stake 402 and injuring the operator as he applies the impact force 408 repeatedly. This is a substantial increase in safety over using one hand to position the stake 402 while striking the stake 402 with a hammer, as would be typical without the embodiment 400.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A device comprising:
a guide comprising:
a guide tube being a first cylinder having a first inner diameter and a first axis and a first end and a second end, said guide tube further having a grip area disposed proximally to said first end;
a receiver being a second cylinder having a second inner diameter, said receiver having a second axis substantially aligned with said first axis, said second inner diameter being larger than said first inner diameter, said receiver being integral with said guide and adapted to extend past said second end distal to first end;
a slide hammer comprising:
a handle;
a hammer shaft adapted to freely slide in said guide tube and extend at least partially into said receiver when said hammer shaft is inserted into said guide tube.

2. The device of claim 1 wherein said handle comprises a finger guard.

3. The device of claim 1 wherein said guide tube comprises a finger guard.

4. The device of claim 1 wherein said slide hammer comprises a weight.

5. A device for driving a stake having a stake diameter, said device comprising:
a guide comprising:
a guide tube being a first cylinder having a first inner diameter and a first axis, said first inner diameter being smaller than said stake diameter and a first end and a second end, said guide tube further having a grip area disposed proximally to said first end;
a receiver being a second cylinder having a second inner diameter, said receiver being adapted to come into contact with and at least partially capture said stake, said receiver having a second axis substantially aligned with said first axis, said second inner diameter being larger than said stake diameter, said receiver being fixedly attached to said second end of said guide and adapted to extend past said second end distal to first end;
a slide hammer comprising:
a handle;
a hammer shaft adapted to freely slide in said guide tube and extend at least partially into said receiver when said hammer shaft is inserted into said guide tube.

6. The device of claim 5 wherein said handle comprises a finger guard.

7. The device of claim 5 wherein said guide tube comprises a finger guard.

8. The device of claim 5 wherein said slide hammer comprises a weight.
